(19) United States
(12) Patent Application Publication
(10) Pub. No.: US 2026/0052178 A1
(43) Pub. Date: Feb. 19, 2026

(54) ADAPTABLE NETWORK SUBSTRATE FOR WORKLOADS WITH DYNAMIC LOCATION PLACEMENT

(71) Applicant: Cisco Technology, Inc., San Jose, CA (US)

(72) Inventors: Alberto Rodriguez-Natal, Leon (ES); Eric Voit, Bethesda, MD (US); Lorand Jakab, Gheorghieni (RO); Josh Halley, Moosburg an der Isar (DE)

(21) Appl. No.: 18/807,295

(22) Filed: Aug. 16, 2024

(51) Int. Cl. H04L 67/1008; H04L 67/101

(52) U.S. Cl. CPC H04L 67/1008; H04L 67/101

(57) ABSTRACT

Techniques for observing network configuration(s) and/or pattern(s) for coordinating workload placement and resource/infrastructure allocation according to present network and/or workload conditions are described herein. A controller of a network may receive telemetry data from resources, associated with a workload orchestrator, that are allocated to host workloads in the network. The controller may also receive workload rules indicative of configuration data associated with a workload that is to be provisioned in the network. Using the telemetry data and the workload rules, the controller may determine specific resources in specific workload environment(s) of the network are most favorable to host the workload. Once the resources and/or the workload environment is determined, the network controller may negotiate with the workload orchestrators to configure resources to host the workload, provision additional resources in a workload environment to host the workload, migrate workloads from first resources in workload environments to second resources, and/or the like.

### TECHNICAL FIELD

The present disclosure relates generally to, among other things, techniques for observing network configuration(s) and/or pattern(s) for coordinating workload placement and computing resource and/or workload infrastructure allocation according to present network and/or workload conditions.

### BACKGROUND

Computing resource networks provide users with access to computing resources and/or network infrastructure to fulfill users' computing resource needs. In some examples, service providers can manage and computing resources to users to fulfill their needs without the users having to invest in and maintain their own computing infrastructure. Such networks may be configured as distributed networks (e.g., workload environment networks) and often involve networks of data centers which house servers, routers, and other devices that provide computing resources to users such as compute resources, networking resources, storage resources, database resources, application resources, and so forth. Users may leverage these computing resources to host their workloads. Placement of these workloads may be very dynamic, particularly in distributed networks (e.g., workload environment networks, hybrid cloud networks, software defined networks (SDNs), software defined wide area networks (SD-WANs) and/or the like), where placement can fluctuate across locations over time. Reasons for such fluctuation may be due to highly variable load, resource availability, and/or financial cost across locations that vary overtime. With many possible locations for workload placement in current hybrid cloud ecosystems, customers may find it beneficial to move workloads around to ensure capacity for optimal operation and/or to reduce costs. However, this requires that the network adapt quickly to changes of workload presence across locations to provide capacity where workloads are planned or expected to be provisioned, while reducing resource allocation in locations where workloads are leaving. Considering that the network may need to support the hosting of workloads that shift locations overtime, there is a need for the network to be aware of the dynamics regarding workload placement.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an example environment and flow for coordinating workload placement and computing resource and/or network infrastructure allocation according to present network and/or workload conditions.

FIG. 2 illustrates an example diagram of computing resource load distribution in workload environment networks over time according to the techniques disclosed herein.

FIG. 3 illustrates a flow diagram of an example method for performing computing resource and/or network infrastructure load distribution and/or dynamic workload placement in a workload environment network over time according to the techniques disclosed herein.

FIG. 4 illustrates a flow diagram of another example method for performing computing resource and/or network infrastructure load distribution and/or dynamic workload placement in a workload environment network over time according to the techniques disclosed herein.

FIG. 5 illustrates a computing system diagram illustrating a configuration for a data center that can be utilized to implement aspects of the technologies disclosed herein.

FIG. 6 is a computer architecture diagram showing an illustrative computer hardware architecture for implementing a server device that can be utilized to implement aspects of the various technologies presented herein.

### DESCRIPTION OF EXAMPLE EMBODIMENTS

### Overview

This disclosure describes method(s) to observe network configuration(s) and/or pattern(s) for coordinating workload placement and computing resource and/or network infrastructure allocation and/or configuration according to present network and/or workload conditions. The method may include receiving, at a network controller associated with a workload environment network, an indication that a first workload is to be provisioned in the workload environment network. Additionally, or alternatively, the method may include receiving, at the network controller, telemetry data from resources associated with a workload orchestrator allocated to host the first workload. In some examples, the telemetry data may include at least first telemetry data from first resources associated with the workload orchestrator allocated to host the first workload, the first resources being located in a first workload environment of the workload environment network. Additionally, or alternatively, the telemetry data may include at least second telemetry data from second resources associated with the workload orchestrator allocated to host the first workload, the second resources being located in a second workload environment of the workload environment network that is different from the first workload environment. Additionally, or alternatively, the method may include receiving, at the network controller, workload rules indicative of configuration data associated with the first workload. Additionally, or alternatively, the method may include determining, by the network controller and based at least in part on the telemetry data and the workload rules, that the first resources are more optimized to host the first workload than the second resources. Additionally, or alternatively, the method may include configuring the first resources to host the first workload based at least in part on the first resources being more favorable to host the first workload than the second resources. Additionally, or alternatively, the method may include allocating third resources associated with the workload orchestrator to host the first workload in the first workload environment of the workload environment network based at least in part on the first resources being more favorable to host the first workload than the second resources. Additionally, or alternatively, the method may include migrating a second workload from the first resources in the first workload environment to the second resources in the second workload environment based at least in part on the first resources being more favorable to host the first workload than the second resources.

Additionally, or alternatively, the method may include receiving, at a network controller associated with a workload environment network, an indication that a first workload is to be provisioned in the workload environment network. Additionally, or alternatively, the method may include receiving, at the network controller, telemetry data from resources associated with a workload orchestrator allocated to host the first workload. In some examples, the telemetry data may include at least first telemetry data from first resources associated with the workload orchestrator allocated to host the first workload. Additionally, or alternatively, the telemetry data may include at least second telemetry data from second resources associated with the workload orchestrator allocated to host the first workload. Additionally, or alternatively, the method may include receiving, at the network controller, workload rules indicative of configuration data associated with the first workload. Additionally, or alternatively, the method may include determining, by the network controller and based at least in part on the telemetry data and the workload rules, that the first resources are more favorable to host the first workload than the second resources. Additionally, or alternatively, the method may include configuring the first resources to host the first workload based at least in part on the first resources being more favorable to host the first workload than the second resources.

The techniques described herein may be performed as a method and/or by a system having non-transitory computer-readable media storing computer-executable instructions that, when executed by one or more processors, cause the system to perform the techniques described above and herein.

### Example Embodiments

As previously described, distributed networks (e.g., hybrid cloud networks, software defined networks (SDNs), software defined wide area networks (SD-WANs) and/or the like) provide users with computing resources to host workloads, where placement of such workloads can fluctuate across locations over time. Configuring the network to adapt quickly to changes of workload presence across locations can be difficult since the network has to provide capacity where workloads are planned or expected to be provisioned, while reducing resource allocation in locations where workloads are leaving or migrating away from. Considering that the network may need to support the hosting of workloads that shift locations overtime, there is a need for the network to be aware of the dynamics regarding workload placement without having to rely on or wait for a network administrator to provide and/or reduce resource allocation in various locations across a distributed network.

This application describes techniques for observing network configuration(s) and/or pattern(s) to coordinate workload placement and computing resource allocation according to present network and/or workload conditions. In some examples, a network controller of a workload environment network may be configured to coordinate with workload orchestrators to manage allocation of resources configured to host workloads and/or the placement of such workloads in the workload environment network according to present network and/or workload conditions. That is, a network controller may receive telemetry data from resources associated with a workload orchestrator that are allocated to host one or more workloads that are to be provisioned in a workload environment network. The telemetry data may be collected via one or more workload and/or network analytics tools, such as, for example, ThousandEyes, Splunk, and/or the like, and leveraged by the network controller to obtain telemetry data indicative of operational state(s) associated with resources located in various workload environments of the workload environment network, such as, for example, cloud networks (e.g., private cloud networks, public cloud networks, regions of cloud networks, etc.), enterprise networks, colocation networks, and/or the like. Additionally, or alternatively, the network controller may obtain workload rules associated with the workload(s) to be provisioned in the workload environment network indicative of various configuration data associated with the workload(s). The network controller may utilize the telemetry data and/or the workload rules to determine which environments of the workload environment network and/or resources in the environments of the workload environment networks are most favorable (e.g., best optimized, more preferred, etc.) to host the workload(s) that are to be provisioned and/or placed. In some examples, the network controller may configure available resources in a given workload environment to host the workload(s), allocate additional resources to a given workload environment to host the workload(s), and/or migrate workloads from first resources in a first workload environment of the workload environment network to second resources in a second workload environment of the workload environment network, according the techniques described herein.

A workload environment network may be configured with a network controller and/or one or more workload environments. In some examples, the workload environments include computing resources configured to host workloads in the workload environment network and/or a workload orchestrator configured to allocate (e.g., increase and/or decrease) the computing resources and/or dynamically place the workloads in the workload environments. That is, the network controller may be communicatively coupled to the workload orchestrators in the workload environments of the workload environment network. As previously described, the network controller may leverage one or more workload analytic tools configured to collect telemetry data indicative of operational state(s) associated with the resources in the workload environments and send the telemetry data to the network controller. Additionally, or alternatively, the network controller may receive workload rules associated with workloads to be provisioned and/or migrated in the workload environment network. In some examples, the telemetry data and/or workload rules may be collected and/or observed over a period of time such that the network controller may make determinations regarding when and how workload placement happens and/or is going to happen according to such data. The network controller may leverage this collected telemetry data and/or workload rules to make various decisions regarding provisioning computing resources throughout the workload environment network and/or placing the workloads throughout the workload environment network.

Take, for example, a first workload to be provisioned in the workload environment network. The network controller may receive an indication that the first workload needs to be provisioned in the workload environment network. In some examples, the first workload may be configured as a workload that is new to the network and needs an initial placement in the network. Additionally, or alternatively, the first workload may be configured as an existing workload in the network (e.g., following an initial placement) being hosted on resources in an environment that is scheduled to migrate to different resources within the same environment and/or in a different environment than it was initially hosted in. That is, the indication regarding placement of the first workload may come by way of a network administrator configuring the first workload for placement and/or via an automation that is configured with respect to the first workload.

The network controller may then leverage telemetry data indicative of operational state(s) of computing resources in the workload environment(s) of the workload environment network. In some examples, a workload analytics tool (also referred to herein as a network analytics tool) may be leveraged by the network controller to obtain such telemetry data, such as, for example, ThousandEyes, Splunk, and/or the like. Additionally, or alternatively, the workload analytics tool(s) may be an external workload analytics tool hosted separately from the network controller and/or the workload environment network and/or the workload analytics tool(s) may be an internal workload analytics tool hosted in association with the workload environment network. The telemetry data collected by the workload analytics tool may be indicative of various operational state(s) and/or tolerances associated with resources in a workload environment and/or the workload environment as a whole. In some examples, the telemetry data may indicate one or more components and/or functionality that are offered by resources in a given workload environment, various quality of service (QoS) metrics associated with resources in a given workload environment (e.g., bandwidth and/or latency guarantees/baselines, how resilient the resources are to network failures, etc.), a current operational load associated with resources in a given workload environment, operational costs associated with resources in a given workload environment, a geographic location associated with resources in a given workload environment, and/or the like.

The network controller may also receive workload rules associated with the workloads provisioned and/or to be provisioned in the workload environment network. The workload rules may be received from the workload orchestrator(s) associated with the workload environments. In some examples, the workload rules may be indicative of configuration data and/or components and/or functionality that the workload requires to function properly. For example, the workload rules may indicate specific network and/or computing resource components required by the workload (e.g., a machine learning workload may require one or more graphics processing units (GPUs) to execute its specific function), various QoS requirements associated with the workload (e.g., bandwidth and/or latency requirements of the workload), threshold limits associated with the workload (e.g., operational cost limits associated with executing the workload, network failure limits associated with the workload, geographical distance limits between the workload and one or more associated workloads, services, and/or devices, etc.), and/or one or more policies defined for the workload. Additionally, or alternatively, the workload rules may be indicative of automation tasks configured for a given workload. In some examples, the automation tasks may include various triggers associated with the provisioning of a given workload, such as, for example, a time at which a workload is configured to migrate between resources and/or workload environments, a threshold cost associated with the resources hosting the workload that is not to be exceeded (e.g., migrating from resources that become too costly to resources that are lower in operational cost), a threshold bandwidth that the resources are to maintain for the workload to function properly, a threshold latency that the resources are not to exceed for the workload to function properly, and/or the like.

The network controller may also be configured to determine which resources are most favorable to host a given workload, predict which resources will be configured to host a given workload, and/or recommend specific resources of a particular workload environment to host a given workload. For instance, the telemetry data learned about the computing resources can provide various indications to the network controller as to whether or not the resources in a given workload environment are optimal for hosting a workload to be placed in the network. When the network controller leverages this telemetry data in tandem with the workload rules, the network controller may make intelligent decisions about the placement of the workloads across the workload environment network. For instance, the telemetry data may indicate that first resources in a first workload environment include one or more GPUs, whereas second resources in a second workload environment do not include GPUs. As such, a workload that requires a GPU to function properly will be placed in the first workload environment that offers resources having GPUs instead of the second workload environment that offers resources without GPUs. Additionally, or alternatively, the telemetry data may indicate that first resources in a first workload environment are at an operational load capacity and/or above a threshold operational load, and as such, the network controller may determine to configure second resources in a second workload environment that is below a threshold operational capacity to host a workload instead of the first resources. Additionally, or alternatively, a first resources in a first workload environment and second resources in a second workload environment may both satisfy minimum operational requirements that a workload requires of resources to host the workload. In some examples, the network controller and/or network orchestrator(s) may negotiate placement of such a workload in various ways. For instance, the network controller and/or workload orchestrator(s) may determine that the first resources in the first workload environment are more favorable/optimal for hosting the workload than the second resources in the second workload environment based on the first resources having a lower operational load than the second resources (e.g., balancing the operational load across the workload environment network), the first resources being more resilient to network failures than the second resources (e.g., a customer configuring their workload with an emphasis on stability of execution), the first resources being associated with a lower operational cost than the second resources (e.g., a customer configuring their workload to save costs as long as the baseline functionality is met), and/or the like. That is, any combination of these metrics may be leveraged to make a determination with respect to placement, and the scenarios described above are for exemplary purposes and should not be construed as limitations.

The network controller may provision resources to host a workload based on the determinations made using the telemetry data and/or the workload rules. For example, the network controller may negotiate placement of a workload with a workload orchestrator of a given workload environment to provision the resources of the workload environment to host the workload. In some examples, provisioning the resources may include configuring the resources to host a given workload (e.g., configuring settings, spinning up virtual machines, etc.), allocating additional resources to host a given workload in a given workload environment (e.g., configuring standby resources to be an active host for a given workload), migrating a first workload hosted on first resources in a first workload environment to second resources in the first workload environment or a second workload environment, and/or the like. Since the network controller is in communication with the various workload orchestrator(s) throughout the workload environment network, the network controller can provide the network orchestrators with instructions for configuring resources, allocating resources, migrating workloads, and/or the like.

As described herein, a computing-based, network-based, cloud-based service, network device, switch, resource, and/or server can generally include any type of resources implemented by virtualization techniques, such as containers, virtual machines, virtual storage, and so forth. Further, although the techniques described as being implemented in distributed networks, such as, data centers, colocation networks, and/or a cloud computing networks, the techniques are generally applicable for any network of devices managed by any entity where virtual resources are provisioned. In some instances, the techniques may be performed by a schedulers or orchestrator, and in other examples, various components may be used in a system to perform the techniques described herein. The devices and components by which the techniques are performed herein are a matter of implementation, and the techniques described are not limited to any specific architecture or implementation.

The techniques described herein provide various improvements and efficiencies with respect to dynamically adapting to workload placement across various networks of a distributed network. For instance, the techniques described herein include leveraging telemetry data indicative of operational state(s) of computing resources in various workload environments and workload rules indicative of automation tasks and/or configuration data of workloads to be placed in the network to iteratively negotiate placement of workloads with workload orchestrators of the workload environments. By leveraging the telemetry data of the network and the workload rules of the workloads, the network controller may predict, react, and/or recommend placement of workloads across the various workload environments of the network. This increases the stability of the workloads hosted on the network by ensuring that the resources hosting the workloads are equipped to properly execute the workloads. Additionally, customers may tailor their workloads to save on operational costs of the resources while ensuring the resources being utilized meet minimum operational tolerances required by the workload. As a result, the workload environment network may require less operational resources to host all of the workloads in an efficient manner since resources are allocated as needed when a new workload is provisioned in the workload environment network and/or reduced when a workload is migrated from a workload environment and/or goes offline. The techniques described herein also increase network security as workloads will only be provisioned on resources meeting operational thresholds (e.g., having required security functionality) and/or in workload environments meeting such operational thresholds (e.g., cloud networks having network edge functionality).

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

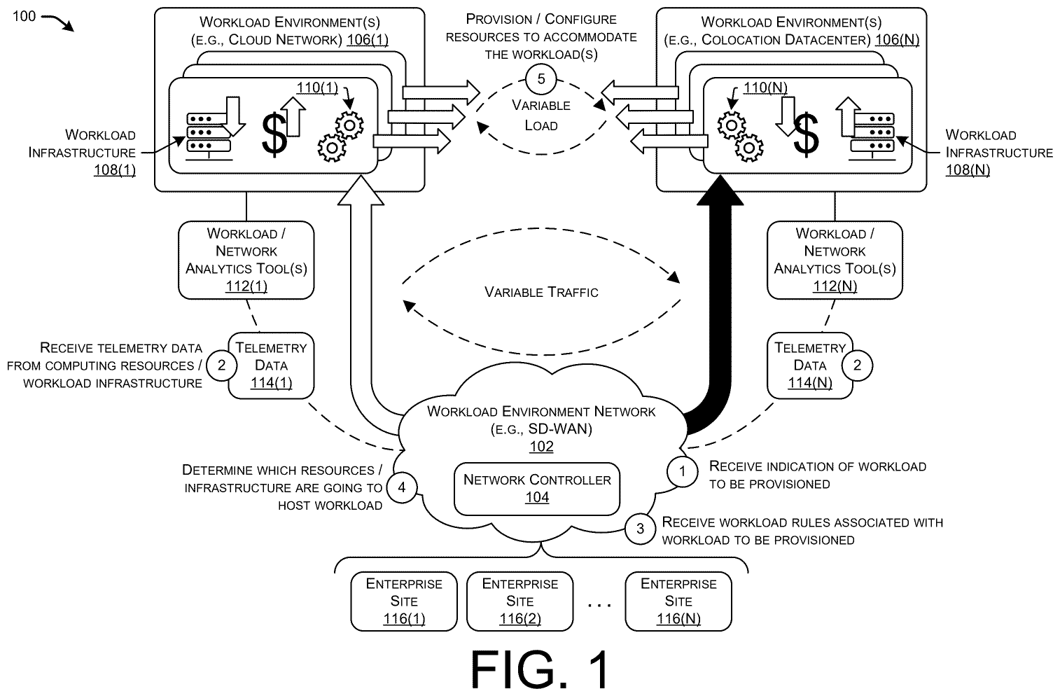

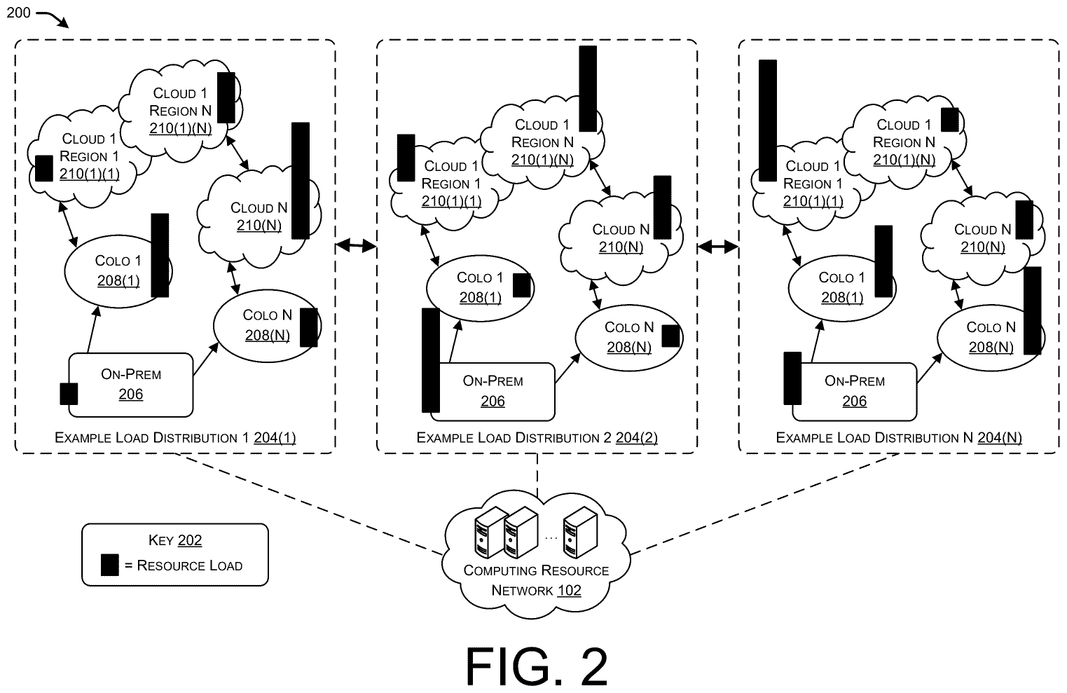

FIGS. 1, 3, and 4 illustrate flow diagrams of example methods (or flows) 100, 300, and 400 that illustrate aspects of the functions performed at least partly by the workload environment network 102 of a network as described in FIGS. 1 and 2. The logical operations described herein with respect to FIGS. 1, 3, and 4 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIGS. 1, 3, and 4, and as described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

FIG. 1 illustrates a system-architecture diagram of an example environment 100 and flow for a workload environment network 102 to coordinate workload placement and computing resource and/or network infrastructure allocation according to present network and/or workload conditions. Generally, the workload environment network 102 may include devices that are housed or located in one or more data centers that may be located at different physical locations. For instance, the workload environment network 102 may be supported by networks of devices in a public cloud computing platform, a private/enterprise computing platform, and/or any combination thereof. The one or more data centers may be physical facilities or buildings located across geographic areas that are designated to store networked devices that are part of the workload environment network 102. The data centers may include various networking devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as processor (CPU), memory (RAM), storage (disk), and networking (bandwidth). However, in some examples the devices in the workload environment network 102 may not be located in explicitly defined data centers and, rather, may be located in other locations or buildings.

The environment 100 may include a workload environment network 102 comprising a network controller 104 and/or one or more workload environments 106(1)-(N) (also referred to herein as workload environments), where N may be any integer greater than 1. In some examples, the workload environments 106 include workload infrastructure 108 (also referred to herein as computing resources and/or network resources/infrastructure) configured to host workloads in the workload environment network 102 and/or a workload orchestrator 110 configured to allocate (e.g., increase and/or decrease) the workload infrastructure 108 and/or dynamically place the workloads in the workload environments 106. That is, the network controller 104 may be communicatively coupled to the workload orchestrators 110 in the workload environments 106 of the workload environment network 102. Additionally, or alternatively, the environment 100 may include one or more workload analytics tool(s) 112(1)-(N) (also referred to herein as network analytics tool(s) 112) configured to collect telemetry data 114(1)-(N) associated with the resources 108 of the various workload environment(s) 106 of the workload environment network 102 over time on behalf of the network controller 104, where N may be any integer greater than 1. In some examples, workload environment network 102 may be configured as a distributed network ((e.g., hybrid cloud networks, software defined networks (SDNs), software defined wide area networks (SD-WANs) and/or the like) and/or the workload environment(s) 106 may be configured as a cloud network (e.g., a private cloud network, a public cloud network, regions of cloud networks, etc.), enterprise networks and/or sites 116, colocation networks, and/or the like.

The workload environment network 102 may offer the workload infrastructure 108 of workload environments 106 to host workloads for customers connected to the workload environment network 102 over one or more networks, such as the internet. The workload environment network 102 and/or the workload environments 106, may each respectively include one or more networks implemented by any viable communication technology, such as wired and/or wireless modalities and/or technologies. The workload environment network 102 and/or the workload environments 106 may each include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The workload environment network 102 may include devices, virtual resources, or other nodes that relay packets from one network segment to another by nodes in the computer network.

In some examples, the network controller 104 may be configured to coordinate with the workload orchestrators 110(1)-(N) to manage allocation of resources 108(1)-(N) configured to host workloads and/or the placement of such workloads in the workload environment network 102 according to present network and/or workload conditions, where N may be any integer greater than 1. That is, the network controller 104 may receive telemetry data from the resources 108 associated with a workload orchestrator 110 that are allocated to host one or more workloads that are to be provisioned in a workload environment network 102. As described above, the telemetry data 114 may be collected via one or more workload analytics tools 112, such as, for example, ThousandEyes, Splunk, and/or the like, and leveraged by the network controller 104 to obtain telemetry data indicative of operational state(s) associated with the resources 108 located in the workload environments 106 of the workload environment network 102. Additionally, or alternatively, the network controller 104 may obtain workload rules associated with the workload(s) to be provisioned on resources 108 and/or migrated to and/or from resources 108 in the workload environment network 102. In some examples, the workload rules may be indicative of various configuration data associated with the workload(s). The network controller 104 may utilize the telemetry data 112 and/or the workload rules to determine which environments 106 of the workload environment network 102 and/or resources 106 in the environments 108 of the workload environment networks are most favorable (e.g., best optimized, most optimal, more preferred, etc.) to host the workload(s) that are to be provisioned and/or placed. In some examples, the network controller 104 may configure available resources 108 in a given workload environment 106 to host the workload(s), allocate additional resources 108 to a given workload environment 106 to host the workload(s), and/or migrate workloads from first resources 108(1) in a first workload environment 106(1) of the workload environment network 102 to second resources 108(N) in a second workload environment 106(N) of the workload environment network 102, according the techniques described herein.

As previously described, the workload environments 106 may include workload infrastructure 108 configured to host workloads in the workload environment network 102 and/or a workload orchestrator 110 configured to allocate (e.g., increase and/or decrease) the workload infrastructure 108 and/or dynamically place the workloads in the workload environments 106. That is, the network controller 104 may be communicatively coupled to the workload orchestrators 110 in the workload environments 106 of the workload environment network 102. As previously described, the network controller 104 may leverage one or more workload analytic tools 112 configured to collect telemetry data 114 indicative of operational state(s) associated with the resources 108 in the workload environments 106 and send the telemetry data 114 to the network controller 104. Additionally, or alternatively, the network controller 104 may receive workload rules associated with workloads to be provisioned and/or migrated in the workload environment network 102. In some examples, the telemetry data 114 and/or workload rules may be collected and/or observed over a period of time such that the network controller 104 may make determinations regarding when and/or how workload placement happens and/or is going to happen according to such data. The network controller 104 may leverage this collected telemetry data 114 and/or workload rules to make various decisions regarding provisioning workload infrastructure 108 throughout the workload environment network 102 and/or placing the workloads throughout the workload environments 106 of the workload environment network 102.

As described above, the network controller 104 and/or workload orchestrator(s) 110 may be configured to iteratively negotiate placement of workloads across workload environments 106 of a workload environment network 102. That is, the network controller 104 may be configured to predict, react, and/or recommend placement of workloads within the workload environment network 102 based on the collected telemetry data 114 indicative of the operational state of resources 108 of the computing resource environment 102 and/or the workload rules associated with workloads that are to be provisioned in the workload environment network 102. An example flow for a network controller 104 to perform the dynamic workload placement and/or workload infrastructure 108 allocation is described below.

At “1,” the network controller 104 may receive an indication that the first workload needs to be provisioned in the workload environment network 102. In some examples, the first workload may be configured as a workload that is new to the workload environment network 102 and needs an initial placement in the workload environment network 102. Additionally, or alternatively, the first workload may be configured as an existing workload in the workload environment network 102 (e.g., following an initial placement) being hosted on resources 108 in an environment 106 and being scheduled to migrate to different resources 108 within the same environment 106 and/or in a different environment 106 than it was initially hosted in. That is, the indication regarding placement of the first workload may come by way of a network administrator configuring the first workload for placement and/or via an automation that is configured with respect to the first workload.

At “2,” the network controller 104 may receive telemetry data 114 from the resources 108 in the workload environments 106 of the workload environment network 102. As mentioned above, the telemetry data 114 may be indicative of the current operational state(s) of the workload infrastructure 108 in the workload environment(s) 106 of the workload environment network 102. In some examples, the workload analytics tool(s) 112 may be leveraged by the network controller 104 to obtain such telemetry data 114, such as, for example, ThousandEyes, Splunk, and/or the like. Additionally, or alternatively, the workload analytics tool(s) 112 may be an external workload analytics tool 112 hosted separately from the network controller 104 and/or the workload environment network 102 and/or the workload analytics tool(s) 112 may be an internal workload analytics tool 112 hosted in association with the workload environment network 102. The telemetry data 114 collected by the workload analytics tool 112 may be indicative of various operational state(s) and/or tolerances associated with resources 108 in a workload environment 108 and/or the workload environment 108 as a whole. In some examples, the telemetry data 114 may indicate one or more components and/or functionality that are offered by the resources 108 in a given workload environment 106, various quality of service (QoS) metrics associated with resources 108 in a given workload environment 106 (e.g., bandwidth and/or latency guarantees/baselines, how resilient the resources are to network failures, etc.), a current operational load associated with resources 108 in a given workload environment 106, operational costs associated with resources 108 in a given workload environment 108, a geographic location associated with resources 106 in a given workload environment 108, and/or the like.

At “3,” the network controller 104 may receive workload rules associated with the workloads provisioned and/or to be provisioned in the workload environment network 102. The workload rules may be received from the workload orchestrator(s) 110 associated with the workload environments 106. In some examples, the workload rules may be indicative of configuration data and/or components and/or functionality that the workload requires to function properly. For example, the workload rules may indicate specific network and/or computing resource components required by the workload (e.g., a machine learning workload may require one or more graphics processing units (GPUs) to execute its specific function), various QoS requirements associated with the workload (e.g., bandwidth and/or latency requirements of the workload), threshold limits associated with the workload (e.g., operational cost limits associated with executing the workload, network failure limits associated with the workload, geographical distance limits between the workload and one or more associated workloads, services, and/or devices, etc.), and/or one or more policies defined for the workload. Additionally, or alternatively, the workload rules may be indicative of automation tasks configured for a given workload. In some examples, the automation tasks may include various triggers associated with the provisioning of a given workload, such as, for example, a time at which a workload is configured to migrate between resources 108 and/or workload environments 106, a threshold cost associated with the resources 108 hosting the workload that is not to be exceeded (e.g., migrating from resources that become too costly to resources 108 that are lower in operational cost), a threshold bandwidth that the resources 108 are to maintain for the workload to function properly, a threshold latency that the resources 108 are not to exceed for the workload to function properly, and/or the like.

At “4,” the network controller 104 may be configured to determine which resources 108 are most favorable to host a given workload, predict which resources 108 will be configured to host a given workload, and/or recommend specific resources 108 of a particular workload environment 106 to host a given workload. For instance, the telemetry data 114 learned about the workload infrastructure 108 can provide various indications to the network controller 104 as to whether or not the resources 108 in a given workload environment 106 are optimal for hosting a workload to be placed in the workload environment network 102. When the network controller 104 leverages this telemetry data in tandem with the workload rules, the network controller 104 may make intelligent decisions about the placement of the workloads across the workload environment network 102.

For instance, the telemetry data 114 may indicate that first resources 108(1) in a first workload environment 106(1) include one or more GPUs, whereas second resources 108(N) in a second workload environment 106(N) do not include GPUs. As such, a workload that requires a GPU to function properly will be placed in the first workload environment 106(1) that offers resources 108(1) having GPUs instead of the second workload environment 106(N) that offers resources 108(N) without GPUs. Additionally, or alternatively, the telemetry data 114 may indicate that first resources 108(1) in a first workload environment 106(1) are at an operational load capacity and/or above a threshold operational load, and as such, the network controller 104 may determine to configure second resources 108(N) in a second workload environment 106(N) that is below a threshold operational capacity to host a workload instead of the first resources 108(1).

Additionally, or alternatively, first resources 108(1) in a first workload environment 106(1) and second resources 108(N) in a second workload environment 106(N) may both satisfy minimum operational requirements that a workload requires of resources 108 to host the workload. In some examples, the network controller 104 and/or network orchestrator(s) 110 may negotiate placement of such a workload in various ways. For instance, the network controller 104 and/or workload orchestrator(s) 110 may determine that the first resources 108(1) in the first workload environment 106(1) are more favorable/optimal for hosting the workload than the second resources 108(N) in the second workload environment 106(N) based on the first resources 108(1) currently having a lower operational load than the second resources 108(N) (e.g., to balance the operational load across the workload environment network 102), the first resources 108(1) being more resilient to network failures than the second resources 108(N) (e.g., a customer configuring their workload with an emphasis on stability of execution and network reliability regardless of cost, load, etc.), the first resources 108(1) being associated with a lower operational cost than the second resources 108(N) (e.g., a customer configuring their workload to save costs as long as the baseline functionality is met by the resources 108 hosting the workload), and/or the like. That is, any combination of these metrics may be leveraged to make a determination with respect to placement, and the scenarios described above are for exemplary purposes and should not be construed as limitations.

At “5,” the network controller may provision resources to host a workload based on the determinations made using the telemetry data 114 and/or the workload rules. For example, the network controller 104 may negotiate placement of a workload with a first workload orchestrator 110(1) of a first workload environment 106(1) to provision the first resources 108(1) of the workload environment to host the workload. In some examples, provisioning the resources 108 may include configuring the first resources 108(1) to host a given workload (e.g., configuring settings, spinning up virtual machines, etc.), allocating additional resources 108 to host a given workload in a given workload environment 106 (e.g., configuring standby resources 108 to be an active host for a given workload), migrating a first workload hosted on first resources 108(1) in a first workload environment 106(1) to second resources 108 in the first workload environment 106(1) or a second workload environment 106(N), and/or the like. Since the network controller 104 is in communication with the various workload orchestrator(s) 110 throughout the workload environment network 102, the network controller 104 can provide the network orchestrators 110 with instructions for configuring resources 108, allocating resources 108, migrating workloads, and/or the like. An example of load distribution of resources 108 across the various workload environments 106 of the workload environment network 102 is described in more detail below with respect to FIG. 2.

FIG. 2 illustrates an example diagram 200 of computing resource load distribution in workload environment network(s) 104 over time according to the techniques disclosed herein. The diagram 200 includes a key 202 illustrating that the resource load for a given workload environment is indicated by the black bars. A larger black bar indicates a larger load distribution than a smaller black bar. The example load distributions 204(1)-(N) represent the same example network at various points in time to illustrate how the computing resource load is distributed across the workload environments of the workload environment network 102, where N may be any integer greater than 1. While three example load distributions 204 are illustrated in FIG. 2, it should be understood that any number of load distributions may be configured for the workload environment network 102. In some examples, the workload environment(s) 106(1)-(N) as described with respect to FIG. 1 may be configured as any one of an on-premises workload environment 206, one or more colocation networks 208(1)-(N), one or more cloud networks 210(1)-(N) (e.g., public cloud networks, private cloud networks, etc.), and/or one or more cloud regions 210(1)(1)-(1)(N) of a cloud network 210, where N may be any integer greater than 1.

The example load distribution(s) 204(1)-(N) represent the workload environment network 102 including an on-premises workload environment 206, a first colocation workload environment 208(1), a second colocation workload environment 208(N), a first cloud network workload environment 210(1) having a first region of the first cloud network workload environment 210(1)(1) and a second region of the first cloud network workload environment 210(1)(N), and/or a second cloud network workload environment 210(N).

As illustrated in the first example load distribution 204(1), the second cloud network workload environment 210(N) has the highest load distribution, followed by the first colocation workload environment 208(1), the second region of the first cloud network workload environment 210(1)(N), the second colocation workload environment 208(N), the first region of the first cloud network workload environment 210(1)(1), and finally the on-premises workload environment 206. In some examples, the first example load distribution 204(1) may represent the distribution of computing resources and/or workloads throughout the workload environment network 102 at a first time.

Additionally, or alternatively, as illustrated in the second example load distribution 204(2), the on-premises workload environment 206 has the highest load distribution, followed by the second region of the first cloud network workload environment 210(1)(N), the second cloud network workload environment 210(N), the first region of the first cloud network workload environment 210(1)(1), the first colocation workload environment 208(1), and finally the second colocation workload environment 208(N). In some examples, the first example load distribution 204(1) may represent the distribution of computing resources and/or workloads throughout the workload environment network 102 at a second time that is different from the first time.

Additionally, or alternatively, as illustrated in the third example load distribution 204(N), the first region of the first cloud network workload environment 210(1)(1) has the highest load distribution, followed by the second colocation workload environment 208(N), the first colocation workload environment 208(1), the on-premises workload environment 206, the second cloud network workload environment 210(N), and finally the second region of the first cloud network workload environment 210(1)(N). In some examples, the third example load distribution 204(N) may represent the distribution of computing resources and/or workloads throughout the workload environment network 102 at a third time that is different from the first time and/or the second time.

In some examples, the network controller 104 may, according to the techniques described above with respect to FIG. 1, utilize the telemetry data 114 and/or the workload rules to negotiate the placement of workloads across the workload environments 106 according to the current load of the workload environments. For instance, consider the workload environment network 102 currently operating at the first time according to the first example load distribution 204(1), the network controller 104 may determine that the second cloud network workload environment 210(N) has the most optimal resources to host a given workload that is to be placed in the workload environment network 102. However, when negotiating placement with a corresponding workload orchestrator 110, the network controller may determine to place the workload in a different workload environment 106 having less current operational load and computing resources that meet minimum operational requirements of the workload, such as, for example, the first region of the second cloud network workload environment 210(1)(1).

Additionally, or alternatively, the network controller 104 may determine that the second cloud network workload environment 210(N), while being at an operational capacity, is the only workload environment 106 having components and/or functionality required by the workload to be placed. For example, the network controller 104, may determine, based on the workload rules that the workload requires a workload environment 106 having resources 108 that include a GPU, and may also determine, based on the telemetry data 114, that the only workload environment 106 having resources 108 including a GPU is the second cloud network workload environment 210(N). As such, the network controller 104 may negotiate with a workload orchestrator 110 to move one or more existing workloads (e.g., workloads that do not require a GPU) hosted on resources 108 of the second cloud network workload environment 210(N) to another workload environment 106 (e.g., the first region of the second cloud network workload environment 210(1)(1)) having resources 108 that meet minimum operational thresholds associated with hosting the existing workloads to free up a sufficient amount of resources 108 of the second cloud network workload environment 210(N) such that the new workload may be placed in the second cloud network workload environment 210(N).

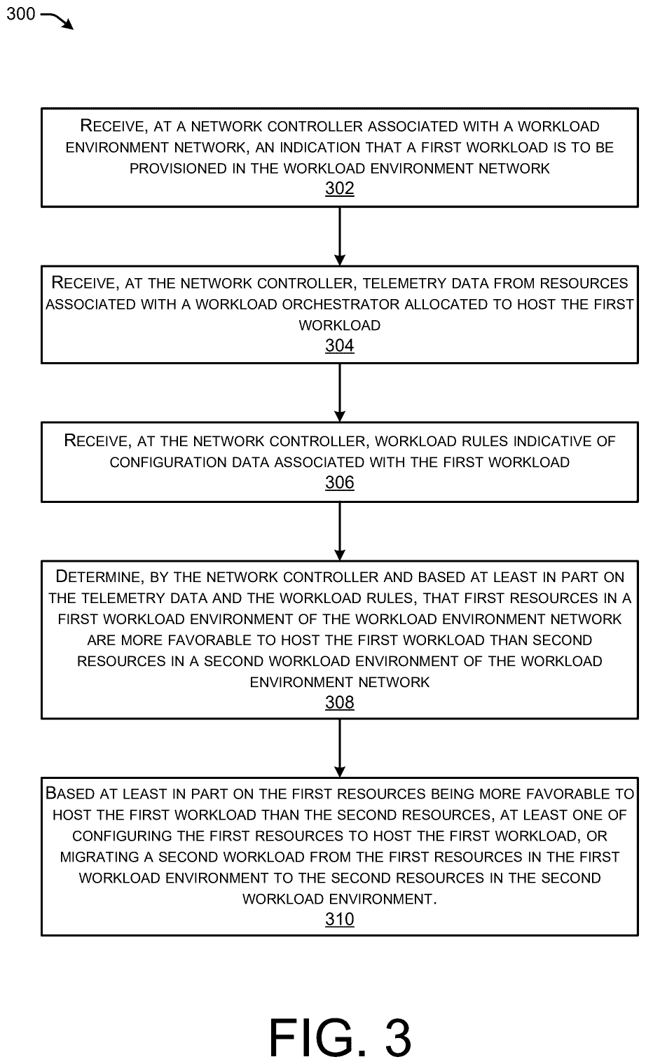

FIG. 3 illustrates a flow diagram of an example method 300 for performing computing resource load distribution and/or dynamic workload placement in a workload environment network over time according to the techniques disclosed herein. In some examples, the workload environment network may correspond to the workload environment network 102 as described with respect to FIGS. 1 and 2.

At 302, the method 300 may include receiving, at a network controller associated with a workload environment network, an indication that a first workload is to be provisioned in the workload environment network. In some examples, the network controller may correspond to the network controller 104 as described with respect to FIG. 1.

At 304, the method 300 may include receiving, at the network controller, telemetry data from resources associated with a workload orchestrator allocated to host the first workload. In some examples, the workload orchestrator may correspond to the workload orchestrator(s) 110 as described with respect to FIG. 1. Additionally, or alternatively, the telemetry data may include first telemetry data from first resources associated with the workload orchestrator allocated to host the first workload. In some examples, the first resources may be located in a first workload environment of the workload environment network. The first workload environment and/or the first resources may correspond to the first workload environment 106(1), the first resources 108(1), and/or the first telemetry data 114(1) as described with respect to FIG. 1. Additionally, or alternatively, the telemetry data may include second telemetry data from second resources associated with the workload orchestrator allocated to host the first workload. In some examples, the second resources may be located in a second workload environment of the workload environment network that is different from the first workload environment. The second workload environment and/or the second resources may correspond to the second workload environment 106(N), the second resources 108(N), and/or the second telemetry data 114(N) as described with respect to FIG. 1.

At 306, the method 300 may include receiving, at the network controller, workload rules indicative of configuration data associated with the first workload.

At 308, the method 300 may include determining that the first resources are more favorable to host the first workload than the second resources. In some examples, determining that the first resources are more favorable to host the first workload than the second resources may be determined by the network controller and based at least in part on the telemetry data and the workload rules.

At 310, the method 300 may include the network controller performing one or more operations to configure the network to host the first workload based at least in part on the first resources being more favorable to host the first workload than the second resources. In some examples, the method 300 may include configuring the first resources to host the first workload based at least in part on the first resources being more favorable to host the first workload than the second resources. Additionally, or alternatively, the method 300 may include allocating third resources associated with the workload orchestrator to host the first workload in the first workload environment of the workload environment network based at least in part on the first resources being more favorable to host the first workload than the second resources. Additionally, or alternatively, the method 300 may include migrating a second workload from the first resources in the first workload environment to the second resources in the second workload environment based at least in part on the first resources being more favorable to host the first workload than the second resources.

In some examples, migrating the second workload from the first resources in the first workload environment to the second resources in the second workload environment may comprise determining that the first resources in the first workload environment are at an operational capacity. Additionally, or alternatively, migrating the second workload from the first resources in the first workload environment to the second resources in the second workload environment may comprise determining that the second resources in the second workload environment satisfy a threshold optimization for hosting the second workload.

In some examples, determining that the first resources are more favorable to host the first workload than the second resources may be based at least in part on at least one of determining that the first resources include one or more network components required to execute the first workload, determining that the first resources have a greater bandwidth than the second resources, determining that the first resources have a lower latency than the second resources, determining that the first workload environment is geographically located closer to at least one of a third workload associated with the first workload or a user device associated with the first workload than the second workload environment, determining that the first resources have a lower operational cost than the second resources, and/or determining that a network policy associated with the first workload indicates that the first workload is to be provisioned in the first workload environment.

In some examples, the configuration data associated with the first workload may include existing automation tasks associated with the first workload. In some examples, the existing automation tasks may be indicative of at least one of a time at which the first workload is configured to migrate from fourth resources of the workload environment network to at least the first resources, a threshold bandwidth associated with executing the first workload, a threshold latency associated with executing the first workload, and/or a threshold operational cost of the resources associated with the workload orchestrator allocated to host the first workload.

In some examples, the first workload may be configured as at least one of a new workload to be provisioned in the workload environment network or an existing workload to be migrated from a workload environment in the workload environment network.

Additionally, or alternatively, the method 300 may include determining, based at least in part on the workload rules associated with the first workload, minimum operational requirements required by the resources associated with the workload orchestrator allocated to host the first workload. Additionally, or alternatively, the method 300 may include determining, based at least in part on the first telemetry data, that the first resources satisfy the minimum operational requirements. Additionally, or alternatively, the method 300 may include determining, based at least in part on the second telemetry data, that the second resources satisfy the minimum operational requirements. Additionally, or alternatively, the method 300 may include determining that the first resources are more favorable to host the first workload than the second resources based at least in part on at least one of determining that the first resources in the first workload environment currently have a lower operational load than the second resources in the second workload environment, determining that the first resources in the first workload environment are more resilient to network failures than the second resources in the second workload environment, determining that the first resources in the first workload environment are associated with a lower operational cost than the second resources in the second workload environment.

Additionally, or alternatively, the method 300 may include reducing the second resources in the second workload environment based at least in part on configuring the first resources to host the first workload. Additionally, or alternatively, the method 300 may include increasing the second resources in the second workload environment based at least in part on migrating the second workload from the first resources in the first workload environment to the second resources in the second workload environment.

In some examples, the first workload environment of the workload environment network may comprise at least one of a first private cloud network, a first public cloud network, a first enterprise network, and/or a first colocation network. Additionally, or alternatively, the second workload environment of the workload environment network may comprise at least one of a second private cloud network, a second public cloud network, a second enterprise network, and/or a second colocation network.

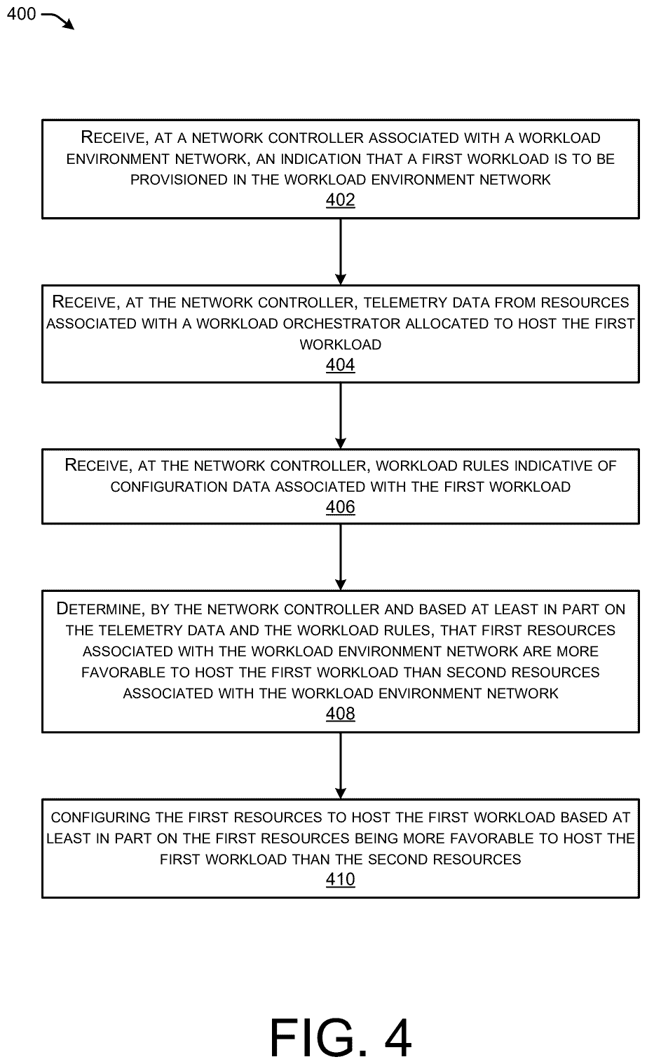

FIG. 4 illustrates a flow diagram of another example method 400 for performing computing resource load distribution and/or dynamic workload placement in a workload environment network over time according to the techniques disclosed herein. In some examples, the workload environment network may correspond to the workload environment network 102 as described with respect to FIGS. 1 and 2.

At 402, the method 400 may include receiving, at a network controller associated with a workload environment network, an indication that a first workload is to be provisioned in the workload environment network. In some examples, the network controller may correspond to the network controller 104 as described with respect to FIG. 1.

At 404, the method 400 may include receiving, at the network controller, telemetry data from resources associated with a workload orchestrator allocated to host the first workload. In some examples, the workload orchestrator may correspond to the workload orchestrator(s) 110 as described with respect to FIG. 1. Additionally, or alternatively, the telemetry data may include first telemetry data from first resources associated with the workload orchestrator allocated to host the first workload. In some examples, the first resources and/or the first telemetry data may correspond to the first resources 108(1) and/or the first telemetry data 114(1) as described with respect to FIG. 1. Additionally, or alternatively, the telemetry data may include second telemetry data from second resources associated with the workload orchestrator allocated to host the first workload. In some examples, the second resources and/or the second telemetry data may correspond to the second resources 108(N) and/or the second telemetry data 114(N) as described with respect to FIG. 1.

At 406, the method 400 may include receiving, at the network controller, workload rules indicative of configuration data associated with the first workload.

At 408, the method 400 may include determining that the first resources are more favorable to host the first workload than the second resources. In some examples, determining that the first resources are more favorable to host the first workload than the second resources may be determined by the network controller and based at least in part on the telemetry data and the workload rules.

At 410, the method 400 may include configuring the first resources to host the first workload based at least in part on the first resources being more favorable to host the first workload than the second resources.

In some examples, the telemetry data may be received from an external workload analytics tool configured to collect the telemetry data over a period of time. In some examples, the workload analytics tool may correspond to the workload analytics tool(s) 112 as described with respect to FIG. 1.

In some examples, determining that the first resources are more favorable to host the first workload than the second resources may be based at least in part on at least one of determining that the first resources include one or more network components required to execute the first workload, determining that the first resources have a greater bandwidth than the second resources, determining that the first resources have a lower latency than the second resources, determining that the first resources are geographically located closer to at least one of a second workload associated with the first workload or a user device associated with the first workload than the second resources, determining that the first resources have a lower operational cost than the second resources, and/or determining that a network policy associated with the first workload indicates that the first workload is to be hosted on the first resources.

In some examples, the configuration data associated with the first workload may include existing automation tasks associated with the first workload. Additionally, or alternatively, the existing automation tasks being indicative of at least one of a time at which the first workload is configured to migrate from third resources associated with the workload environment network to at least the first resources, a threshold bandwidth associated with executing the first workload, a threshold latency associated with executing the first workload, and/or a threshold operational cost of the resources associated with the workload orchestrator allocated to host the first workload.

In some examples, the first workload may be configured as at least one of a new workload to be provisioned in the workload environment network or an existing workload to be migrated from third resources in the workload environment network.

Additionally, or alternatively, the method 400 may include determining, based at least in part on the workload rules associated with the first workload, minimum operational requirements required by the resources associated with the workload orchestrator allocated to host the first workload. Additionally, or alternatively, the method 400 may include determining, based at least in part on the first telemetry data, that the first resources satisfy the minimum operational requirements. Additionally, or alternatively, the method 400 may include determining, based at least in part on the second telemetry data, that the second resources satisfy the minimum operational requirements. Additionally, or alternatively, the method 400 may include determining that the first resources are more favorable to host the first workload than the second resources based at least in part on at least one of determining that the first resources currently have a lower operational load than the second resources, determining that the first resources are more resilient to network failures than the second resources, and/or determining that the first resources are associated with a lower operational cost than the second resources.

In some examples, the workload environment network may be configured as a hybrid cloud network comprising at least one of a first private cloud network, a first public cloud network, a first enterprise network, and/or a first colocation network.

Additionally, or alternatively, the method 400 may include allocating third resources associated with the workload orchestrator to host the first workload in association with the first resources. Additionally, or alternatively, the method 400 may include reducing the second resources based at least in part on allocating the third resources.

Additionally, or alternatively, the method 400 may include migrating a second workload from the first resources to the second resources based at least in part on configuring the first resources to host the first workload. Additionally, or alternatively, the method 400 may include increasing the second resources based at least in part on migrating the second workload from the first resources to the second resources.

In some examples, migrating the second workload from the first resources to the second resources may comprise determining that the first resources are at an operational capacity. Additionally, or alternatively, migrating the second workload from the first resources to the second resources may comprise determining that the second resources satisfy a threshold optimization for hosting the second workload.

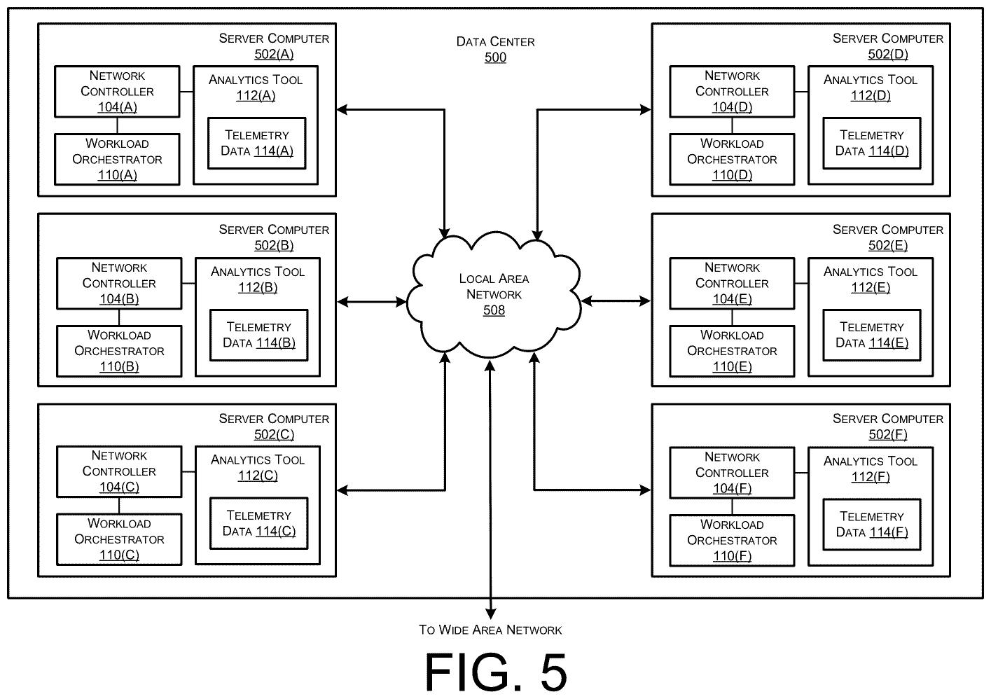

FIG. 5 is a computing system diagram illustrating a configuration for a data center 500 that can be utilized to implement aspects of the technologies disclosed herein. The example data center 500 shown in FIG. 5 includes several server computers 502A-502E (which might be referred to herein singularly as “a server computer 502” or in the plural as “the server computers 502”) for providing computing resources. In some examples, the server computers 502 may include, or correspond to, servers associated with the workload environment network 102 described herein with respect to FIGS. 1 and 2.

The server computers 502 can be standard tower, rack-mount, or blade server computers configured appropriately for providing the computing resources described herein. As mentioned above, the computing resources provided by the workload environment network 102 can be data processing resources such as VM instances or hardware computing systems, database clusters, computing clusters, storage clusters, data storage resources, database resources, networking resources, and others. Some of the servers 502 can also be configured to execute a resource manager capable of instantiating and/or managing the computing resources. In the case of VM instances, for example, the resource manager can be a hypervisor or another type of program configured to enable the execution of multiple VM instances on a single server computer 502. Server computers 502 in the data center 500 can also be configured to provide network services and other types of services.

In the example data center 500 shown in FIG. 5, an appropriate LAN 508 is also utilized to interconnect the server computers 502A-502E. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 500, between each of the server computers 502A-502E in each data center 500, and, potentially, between computing resources in each of the server computers 502. It should be appreciated that the configuration of the data center 500 described with reference to FIG. 5 is merely illustrative and that other implementations can be utilized.

In some examples, the server computers 502 may each execute a network controller 104, a workload orchestrator 110, and/or one or more workload analytics tool(s) 112 configured to collect telemetry data 114 associated with resources of the workload environment network 102.

In some instances, the workload environment network 102, may provide computing resources, like application containers, VM instances, and storage, on a permanent or an as-needed basis. Among other types of functionality, the computing resources provided by the workload environment network 102, may be utilized to implement the various services described above. The computing resources provided by the workload environment network 102, can include various types of computing resources, such as data processing resources like application containers and VM instances, data storage resources, networking resources, data communication resources, network services, and the like.

Each type of computing resource provided by the workload environment network 102, can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The workload environment network 102, can also be configured to provide other types of computing resources not mentioned specifically herein.

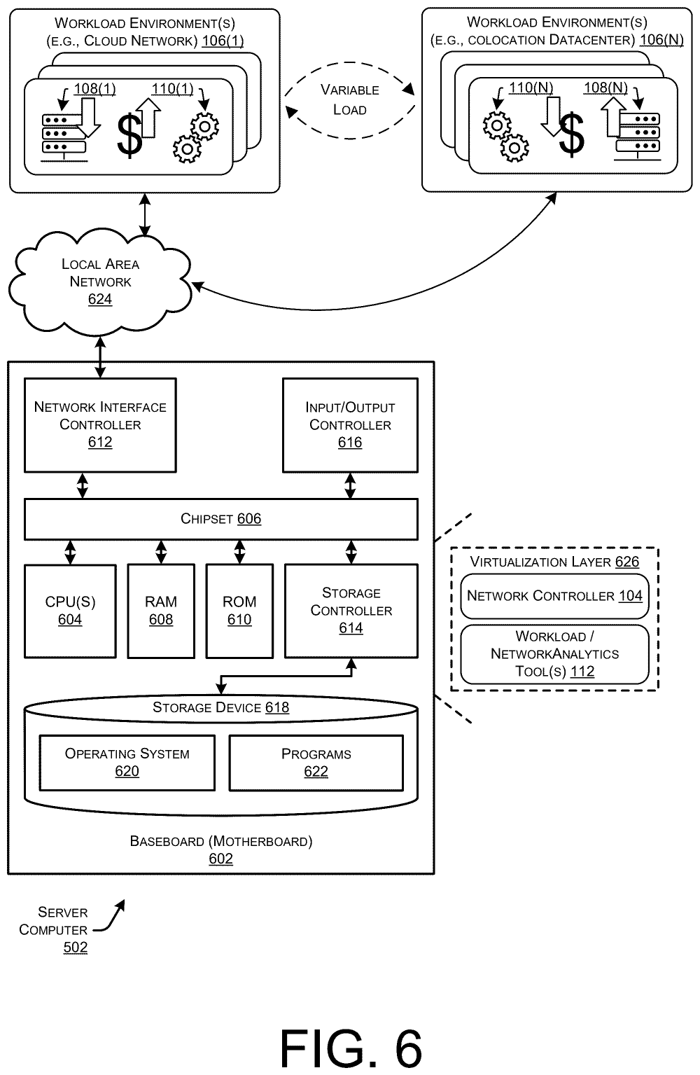

The computing resources provided by the workload environment network 102, may be enabled in one embodiment by one or more data centers 500 (which might be referred to herein singularly as “a data center 500” or in the plural as “the data centers 500”). The data centers 500 are facilities utilized to house and operate computer systems and associated components. The data centers 500 typically include redundant and backup power, communications, cooling, and security systems. The data centers 500 can also be located in geographically disparate locations. One illustrative embodiment for a data center 500 that can be utilized to implement the technologies disclosed herein will be described below with regard to FIG. 6.

FIG. 6 shows an example computer architecture for a computing device (or network routing device) 502 capable of executing program components for implementing the functionality described above. The computer architecture shown in FIG. 6 illustrates a conventional server computer, workstation, desktop computer, laptop, tablet, network appliance, e-reader, smartphone, or other computing device, and can be utilized to execute any of the software components presented herein. The computing device 502 may, in some examples, correspond to a physical server associated with the workload environment network 102 described herein with respect to FIGS. 1 and 2.

The computing device 502 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computing device 502.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computing device 502. The chipset 606 can further provide an interface to a computer-readable storage medium such as a read-only memory (“ROM”) 610 or non-volatile RAM (“NVRAM”) for storing basic routines that help to startup the computing device 502 and to transfer information between the various components and devices. The ROM 610 or NVRAM can also store other software components necessary for the operation of the computing device 502 in accordance with the configurations described herein.

The computing device 502 can operate in a networked environment using logical connections to remote computing devices and computer systems through a network, such as the network 624 (or 508). The chipset 606 can include functionality for providing network connectivity through a NIC 612, such as a gigabit Ethernet adapter. The NIC 612 is capable of connecting the computing device 502 to other computing devices over the network 624. It should be appreciated that multiple NICs 612 can be present in the computing device 502, connecting the computer to other types of networks and remote computer systems.

The computing device 502 can be connected to a storage device 618 that provides non-volatile storage for the computing device 502. The storage device 618 can store an operating system 620, programs 622, and data, which have been described in greater detail herein. The storage device 618 can be connected to the computing device 502 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 502 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computing device 502 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 502 can further read information from the storage device 618 by detecting the physical states or characteristics of one or more particular locations within the physical storage units.

In addition to the mass storage device 618 described above, the computing device 502 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 502. In some examples, the operations performed by the workload environment network 102, and/or any components included therein, may be supported by one or more devices similar to computing device 502. Stated otherwise, some or all of the operations performed by the workload environment network 102, and/or any components included therein, may be performed by one or more computing device 502 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computing device 502. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computing device 502.

In one embodiment, the storage device 618 or other computer-readable storage media is encoded with computer-executable instructions which, when loaded into the computing device 502, transform the computer from a general-purpose computing system into a special-purpose computer capable of implementing the embodiments described herein. These computer-executable instructions transform the computing device 502 by specifying how the CPUs 604 transition between states, as described above. According to one embodiment, the computing device 502 has access to computer-readable storage media storing computer-executable instructions which, when executed by the computing device 502, perform the various processes/methods described above with regard to FIGS. 1, 3, and 4. The computing device 502 can also include computer-readable storage media having instructions stored thereupon for performing any of the other computer-implemented operations described herein.

The computing device 502 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computing device 502 might not include all of the components shown in FIG. 6, can include other components that are not explicitly shown in FIG. 6, or might utilize an architecture completely different than that shown in FIG. 6.

The server computer 502 may support a virtualization layer 626, such as one or more components associated with the workload environment network 102. For example, the workload environment network 102 may comprise a network controller 104 and/or one or more workload analytics tool(s) 112. The network controller 104 may be configured to receive telemetry data 114 from resources 108, associated with a workload orchestrator 110, that are allocated to host workloads in workload environments 106 in the network 102. The controller 104 may also receive workload rules indicative of configuration data associated with a workload that is to be provisioned in the network 102. Using the telemetry data 114 and the workload rules, the controller 104 may determine which resources 108 in which workload environment 106 of the network 102 are most favorable to host the workload. Once the resources 108 and/or the workload environment 106 is determined, the network controller 104 may negotiate with the workload orchestrators 110 to configure resources 108 to host the workload, allocate additional resources 108 in a workload environment 106 to host the workload, migrate workloads from first resources 108 in workload environments 106 to second resources 108, and/or the like.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving, at a network controller associated with a workload environment network, an indication that a first workload is to be provisioned in the workload environment network;
receiving, at the network controller, telemetry data from resources associated with a workload orchestrator allocated to host the first workload, the telemetry data including at least:
first telemetry data from first resources associated with the workload orchestrator allocated to host the first workload, the first resources being located in a first workload environment of the workload environment network; and
second telemetry data from second resources associated with the workload orchestrator allocated to host the first workload, the second resources being located in a second workload environment of the workload environment network that is different from the first workload environment;
receiving, at the network controller, workload rules indicative of configuration data associated with the first workload;
determining, by the network controller and based at least in part on the telemetry data and the workload rules, that the first resources are more favorable to host the first workload than the second resources; and
based at least in part on the first resources being more favorable to host the first workload than the second resources, at least one of:
configuring the first resources to host the first workload; or
migrating a second workload from the first resources in the first workload environment to the second resources in the second workload environment.

2. The method of claim 1, wherein migrating the second workload from the first resources in the first workload environment to the second resources in the second workload environment comprises:
determining that the first resources in the first workload environment are at an operational capacity; and
determining that the second resources in the second workload environment satisfy a threshold optimization for hosting the second workload.

3. The method of claim 1, wherein determining that the first resources are more favorable to host the first workload than the second resources is based at least in part on at least one of:
determining that the first resources include one or more network components required to execute the first workload;
determining that the first resources have a greater bandwidth than the second resources;
determining that the first resources have a lower latency than the second resources;
determining that the first workload environment is geographically located closer to at least one of a third workload associated with the first workload or a user device associated with the first workload than the second workload environment;
determining that the first resources have a lower operational cost than the second resources; or
determining that a network policy associated with the first workload indicates that the first workload is to be provisioned in the first workload environment.

4. The method of claim 1, wherein the configuration data associated with the first workload include existing automation tasks associated with the first workload, the existing automation tasks being indicative of at least one of:
a time at which the first workload is configured to migrate from fourth resources of the workload environment network to at least the first resources;
a threshold bandwidth associated with executing the first workload;
a threshold latency associated with executing the first workload; or
a threshold operational cost of the resources associated with the workload orchestrator allocated to host the first workload.

5. The method of claim 1, wherein the first workload is configured as at least one of a new workload to be provisioned in the workload environment network or an existing workload to be migrated from a workload environment in the workload environment network.

6. The method of claim 1, further comprising:
determining, based at least in part on the workload rules associated with the first workload, minimum operational requirements required by the resources associated with the workload orchestrator allocated to host the first workload;
determining, based at least in part on the first telemetry data, that the first resources satisfy the minimum operational requirements;
determining, based at least in part on the second telemetry data, that the second resources satisfy the minimum operational requirements; and
determining that the first resources are more favorable to host the first workload than the second resources based at least in part on at least one of:
determining that the first resources in the first workload environment currently have a lower operational load than the second resources in the second workload environment;
determining that the first resources in the first workload environment are more resilient to network failures than the second resources in the second workload environment; or
determining that the first resources in the first workload environment are associated with a lower operational cost than the second resources in the second workload environment.

7. The method of claim 1, further comprising at least one of:
reducing the second resources in the second workload environment based at least in part on configuring the first resources to host the first workload; or
increasing the second resources in the second workload environment based at least in part on migrating the second workload from the first resources in the first workload environment to the second resources in the second workload environment.

8. The method of claim 1, wherein:
the first workload environment of the workload environment network comprises at least one of:
a first private cloud network;
a first public cloud network;
a first enterprise network; or
a first colocation network; and
the second workload environment of the workload environment network comprises at least one of:
a second private cloud network;
a second public cloud network;
a second enterprise network; or
a second colocation network.

9. A system comprising:
one or more processors; and
one or more non-transitory computer-readable media storing instructions that, when executed by the one or more processors, cause the one or more processors to perform operations comprising:
receiving, at a network controller associated with a workload environment network, an indication that a first workload is to be provisioned in the workload environment network;
receiving, at the network controller, telemetry data from resources associated with a workload orchestrator allocated to host the first workload, the telemetry data including at least:
first telemetry data from first resources associated with the workload orchestrator allocated to host the first workload; and
second telemetry data from second resources associated with the workload orchestrator allocated to host the first workload;
receiving, at the network controller, workload rules indicative of configuration data associated with the first workload;
determining, by the network controller and based at least in part on the telemetry data and the workload rules, that the first resources are more favorable to host the first workload than the second resources; and
configuring the first resources to host the first workload based at least in part on the first resources being more favorable to host the first workload than the second resources.

10. The system of claim 9, wherein the telemetry data is received from an external workload analytics tool configured to collect the telemetry data over a period of time.

11. The system of claim 9, wherein determining that the first resources are more favorable to host the first workload than the second resources is based at least in part on at least one of:
determining that the first resources include one or more network components required to execute the first workload;
determining that the first resources have a greater bandwidth than the second resources;
determining that the first resources have a lower latency than the second resources;
determining that the first resources are geographically located closer to at least one of a second workload associated with the first workload or a user device associated with the first workload than the second resources;
determining that the first resources have a lower operational cost than the second resources; or
determining that a network policy associated with the first workload indicates that the first workload is to be hosted on the first resources.

12. The system of claim 9, wherein the configuration data associated with the first workload include existing automation tasks associated with the first workload, the existing automation tasks being indicative of at least one of:
a time at which the first workload is configured to migrate from third resources associated with the workload environment network to at least the first resources;
a threshold bandwidth associated with executing the first workload;
a threshold latency associated with executing the first workload; or
a threshold operational cost of the resources associated with the workload orchestrator allocated to host the first workload.

13. The system of claim 9, wherein the first workload is configured as at least one of a new workload to be provisioned in the workload environment network or an existing workload to be migrated from third resources in the workload environment network.

14. The system of claim 9, the operations further comprising:
determining, based at least in part on the workload rules associated with the first workload, minimum operational requirements required by the resources associated with the workload orchestrator allocated to host the first workload;
determining, based at least in part on the first telemetry data, that the first resources satisfy the minimum operational requirements;
determining, based at least in part on the second telemetry data, that the second resources satisfy the minimum operational requirements; and
determining that the first resources are more favorable to host the first workload than the second resources based at least in part on at least one of:
determining that the first resources currently have a lower operational load than the second resources;
determining that the first resources are more resilient to network failures than the second resources; or
determining that the first resources are associated with a lower operational cost than the second resources.

15. One or more non-transitory computer-readable media storing instructions that, when executed by one or more processors, cause the one or more processors to perform operations comprising:
receiving, at a network controller associated with a workload environment network, an indication that a first workload is to be provisioned in the workload environment network;
receiving, at the network controller, telemetry data from resources associated with a workload orchestrator allocated to host the first workload, the telemetry data including at least:
first telemetry data from first resources associated with the workload orchestrator allocated to host the first workload; and
second telemetry data from second resources associated with the workload orchestrator allocated to host the first workload;
receiving, at the network controller, workload rules indicative of configuration data associated with the first workload;
determining, by the network controller and based at least in part on the telemetry data and the workload rules, that the first resources are more favorable to host the first workload than the second resources; and
configuring the first resources to host the first workload based at least in part on the first resources being more favorable to host the first workload than the second resources.

16. The one or more non-transitory computer-readable media of claim 15, wherein the workload environment network is configured as a hybrid cloud network comprising at least one of:
a first private cloud network;
a first public cloud network;
a first enterprise network; or
a first colocation network.

17. The one or more non-transitory computer-readable media of claim 15, the operations further comprising:
configuring third resources associated with the workload orchestrator to host the first workload in association with the first resources; and
reducing the second resources based at least in part on configuring the third resources.

18. The one or more non-transitory computer-readable media of claim 15, the operations further comprising:
migrating a second workload from the first resources to the second resources based at least in part on configuring the first resources to host the first workload; and
increasing the second resources based at least in part on migrating the second workload from the first resources to the second resources.

19. The one or more non-transitory computer-readable media of claim 18, wherein migrating the second workload from the first resources to the second resources comprises:
determining that the first resources are at an operational capacity; and
determining that the second resources satisfy a threshold optimization for hosting the second workload.

20. The one or more non-transitory computer-readable media of claim 15, wherein:
the configuration data associated with the first workload include existing automation tasks associated with the first workload, the existing automation tasks being indicative of at least one of:
a time at which the first workload is configured to migrate from third resources associated with the workload environment network to at least the first resources;
a threshold bandwidth associated with executing the first workload;
a threshold latency associated with executing the first workload; or
a threshold operational cost of the resources associated with the workload orchestrator allocated to host the first workload; and
determining that the first resources are more favorable to host the first workload than the second resources is based at least in part on at least one of:
determining that the first resources include one or more network components required to execute the first workload;
determining that the first resources have a greater bandwidth than the second resources;
determining that the first resources have a lower latency than the second resources;
determining that the first resources are geographically located closer to at least one of a second workload associated with the first workload or a user device associated with the first workload than the second resources;
determining that the first resources have a lower operational cost than the second resources; or
determining that a network policy associated with the first workload indicates that the first workload is to be hosted on the first resources.
